(19) United States
(12) Patent Application Publication
(10) Pub. No.: US 2025/0046519 A1
(43) Pub. Date: Feb. 6, 2025

(54) CERAMIC CAPACITOR

(71) Applicant: AMOTECH CO., LTD., Incheon (KR)

(72) Inventors: Byungguk LIM, Incheon (KR); Yunsuk CHOI, Incheon (KR); Jaeyong SONG, Incheon (KR)

(73) Assignee: AMOTECH CO., LTD., Incheon (KR)

(21) Appl. No.: 18/720,242

(22) PCT Filed: Dec. 5, 2022
(86) PCT No.: PCT/KR2022/019565

§ 371 Date: Jun. 14, 2024

(30) Foreign Application Priority Data
Dec. 16, 2021 (KR) 10-2021-0180749

(51) Int. Cl. H01G 4/012; H01G 4/30

(52) U.S. Cl. CPC H01G 4/012; H01G 4/30

(57) ABSTRACT

The present invention relates to a ceramic capacitor, comprising: a ceramic body having front and rear surfaces facing each other, upper and lower surfaces facing each other, and both end surfaces facing each other; a plurality of first dummy electrodes disposed inside the ceramic body, exposed to one end surface of both end surfaces of the ceramic body, and exposed to the front and rear surfaces of the ceramic body so as to contact one end surface of the ceramic body; and a plurality of second dummy electrodes disposed inside the ceramic body, exposed to the other end surface opposite to the one end surface of both end surfaces of the ceramic body, and exposed to the front and rear surfaces of the ceramic body so as to contact the other end surface of the ceramic body.

### TECHNICAL FIELD

The present disclosure relates to a ceramic capacitor, and more particularly, to a ceramic capacitor including a dummy electrode that is exposed to the outside, having improved tensile strength, and enabling stable bonding upon mounting on a board.

### BACKGROUND ART

A capacitor is used to protect a corresponding part by storing electricity when there is a part for which a voltage needs to be constantly maintained and uniformly and stably supplying electricity required by the part, used to remove noise within an electronic device, or used to transmit only an AC signal from a signal in which a DC and an AC are mixed.

In general, a ceramic capacitor consists of a dielectric, an internal electrode, and an external electrode. The ceramic capacitor has internal electrodes of many layers accumulated within a limited space because electric charges are accumulated between the internal electrodes that face each other, thus implementing miniaturization and a higher capacity. In such a capacitor, a crack is likely to occur at a corner part that is under a lot of stress due to a difference in a coefficient of thermal expansion when the ceramic capacitor is mounted on a board. The ceramic capacitor has a problem in that reliability is reduced because characteristics of the ceramic capacitor are changed by a fine crack and the ceramic capacitor does not operate when two terminals of the ceramic capacitor are circuit-shorted due to the crack.

In particular, a low-capacity ceramic capacitor having a small number of stacks of internal electrodes is likely to have a crack because stress is concentrated on a soldered part upon soldering for electrically connecting an external electrode to a circuit board due to weak tensile strength because the number of stacks of internal electrodes is small. When a crack occurs in the ceramic capacitor, the reliability of the ceramic capacitor is reduced because characteristics required for the ceramic capacitor are changed.

The contents described in the Background Art are to help the understanding of the background of the disclosure, and may include contents that are not a disclosed conventional technology.

### DISCLOSURE

### Technical Problem

An object of the present disclosure is to provide a stack type ceramic capacitor, which applies a dummy electrode that is exposed to the outside, has improved tensile strength by improving a structure thereof, enables stable bonding because bonding power of a solder is increased upon mounting on a board, and may also be applied to various external electrode shapes.

### Technical Solution

A ceramic capacitor according to an embodiment of the present disclosure for solving the above problem includes a ceramic body including front and rear surfaces that face each other, upper and lower surfaces that face each other, and both end surfaces that face each other, a plurality of first dummy electrodes disposed within the ceramic body, exposed to one end surface, among the both end surfaces of the ceramic body, and also exposed to the front and rear surfaces of the ceramic body so as to neighbor the one end surface of the ceramic body, and a plurality of second dummy electrodes disposed within the ceramic body, exposed to the other end surface that is opposite to the one end surface, among the both end surfaces of the ceramic body, and also exposed to the front and rear surfaces of the ceramic body so as to neighbor the other end surface of the ceramic body.

The plurality of first dummy electrodes includes a first lower dummy electrode and a first upper dummy electrode disposed over the first lower dummy electrode. The length of a part of the first lower dummy electrode, which is exposed to the front and rear surfaces of the ceramic body, is longer than the length in which the first upper dummy electrode is exposed to the front and rear surfaces of the ceramic body.

The ceramic capacitor further includes a first bottom electrode and a second bottom electrode disposed on both sides of the lower surface of the ceramic body. A separation distance between ends of the first dummy electrode and the second dummy electrode at which the first dummy electrode and the second dummy electrode face each other is relatively longer than a separation distance between the first bottom electrode and the second bottom electrode.

An interval between the first dummy electrodes and between the second dummy electrodes in a height direction thereof may be 2 μm to 3 μm.

The first dummy electrode and the second dummy electrode may have a symmetrical shape.

In the plurality of first dummy electrodes, a part that is exposed to the front surface of the ceramic body forms an “L” shape.

In the plurality of first dummy electrodes, a part that is exposed to the front surface of the ceramic body may have a shape in which the length of the part is increased from a top thereof toward a bottom thereof.

The ceramic capacitor may further include one or more first and second internal electrodes formed within the ceramic body and including parts that are spaced apart from the both end surfaces of the ceramic body at a certain distance and that overlap each other, and first and second vias configured to connect the first and second internal electrodes to the first and second bottom electrodes.

The first via may be entirely connected to the first internal electrode through the first internal electrode. The second via may be entirely connected to the second internal electrode through the second internal electrode.

At least one of the first and second internal electrodes may be formed on a dielectric layer in which the first and second dummy electrodes have been formed.

A plating layer that covers each of the first and second dummy electrodes may be further formed at each of parts of the first and second dummy electrodes, which are exposed to the front and rear surfaces of the ceramic body.

The plurality of second dummy electrodes includes a second lower dummy electrode and a second upper dummy electrode disposed over the second lower dummy electrode. The length of a part of the second lower dummy electrode, which is exposed to the front and rear surfaces of the ceramic body, is longer than the length in which the second upper dummy electrode is exposed to the front and rear surfaces of the ceramic body.

Alternatively, the ceramic capacitor may further include a first internal electrode disposed within the ceramic body and exposed to one end surface, among the both end surfaces of the ceramic body, a second internal electrode disposed within the ceramic body, exposed to the other end surface that is opposite to the one end surface, among the both end surfaces of the ceramic body, and including a part that overlaps the first internal electrode, a first external electrode disposed in the one end surface of the ceramic body and connected to the first internal electrode, and a second external electrode disposed in the other end surface of the ceramic body and connected to the second internal electrode.

The second dummy electrode may be formed in at least one of dielectric layers in each of which the first internal electrode has been formed. The first dummy electrode may be formed in at least one of dielectric layers in each of which the second internal electrode has been formed.

When the ceramic capacitor is mounted on a board, a solder part in which a solder goes up the first and second dummy electrodes and further surrounds a part of the front and rear surfaces of the ceramic body may be formed at each of a part of the first dummy electrode, which is exposed to the front and rear surfaces of the ceramic body, and a part of the second dummy electrode, which is exposed to the front and rear surfaces of the ceramic body.

The first dummy electrode and the second dummy electrode may not overlap the first and second internal electrodes.

### Advantageous Effects

The present disclosure has effects in that a soldered area is widened by a dummy electrode that is exposed to both ends and front and rear surfaces of the ceramic body although the ceramic capacitor having the bottom electrode is soldered to a board, and thus the ceramic capacitor can be stably bonded to a board due to increased bonding power of a solder.

Furthermore, the present disclosure has effects in that a soldered area is widened by the dummy electrode that is exposed to front and rear surfaces of the ceramic body although the ceramic capacitor having an external electrode is soldered to a board, thus the ceramic capacitor can be stably bonded to a board due to increased bonding power of a solder, and the occurrence of a crack upon mounting on the board can be prevented because the dummy electrode is disposed at a part that is under a lot of stress and reinforces tensile strength of the ceramic capacitor.

### DESCRIPTION OF DRAWINGS

FIG. 1 is a perspective view illustrating a ceramic capacitor according to a first embodiment of the present disclosure.

FIG. 2 is a perspective view illustrating a form in which a plating layer has been formed in the ceramic capacitor according to the first embodiment of the present disclosure.

FIG. 3 is a perspective view illustrating a form in which the ceramic capacitor according to the first embodiment of the present disclosure has been soldered to a board.

FIG. 4 is a longitudinal cross-sectional view illustrating the ceramic capacitor according to the first embodiment of the present disclosure.

FIG. 5 is an exploded perspective view illustrating the ceramic capacitor according to the first embodiment of the present disclosure.

FIG. 6 is an exploded perspective view illustrating a modified example of the ceramic capacitor according to the first embodiment of the present disclosure.

FIG. 7 is a perspective view illustrating a ceramic capacitor according to a second embodiment of the present disclosure.

FIG. 8 is a perspective view illustrating a form in which the ceramic capacitor according to the second embodiment of the present disclosure has been soldered to a board.

FIG. 9 is a front view illustrating the ceramic capacitor according to the second embodiment of the present disclosure.

FIG. 10 is a longitudinal cross-sectional view illustrating the ceramic capacitor according to the second embodiment of the present disclosure.

FIG. 11 is an exploded perspective view illustrating the ceramic capacitor according to the second embodiment of the present disclosure.

FIG. 12 is an exploded perspective view illustrating a modified example of the ceramic capacitor according to the second embodiment of the present disclosure.

### BEST MODE

Hereinafter, preferred embodiments of the present disclosure are described in detail with reference to the accompanying drawings.

The present disclosure is characterized in that a ceramic capacitor can be stably bonded to a board regardless of a shape of an external electrode by applying a dummy electrode under the ceramic capacitor so that tensile strength is improved and improving a shape of the dummy electrode so that a soldered area is widened when the ceramic capacitor is soldered to the board, by considering that a corner part at the bottom of the ceramic capacitor is subjected to much stress by expansion and contraction stress of a solder bonding part attributable to bending stress of the board and a heat shock when the ceramic capacitor is mounted on the board and a crack is likely to occur at the corner part that is under a lot of stress.

The present disclosure is described by being divided into a first embodiment in which a bottom electrode and a dummy electrode have been applied in order to enable application to even various external electrode shapes and a second embodiment in which external electrodes and dummy electrodes in both end surfaces have been applied. In the first embodiment, a ceramic capacitor is stably mounted on a board by widening a soldered area by using a dummy electrode when the ceramic capacitor having a bottom electrode is soldered to the board. In the second embodiment, a ceramic capacitor is stably mounted on a board by widening a soldered area by using a dummy electrode when the ceramic capacitor having an external electrode is soldered to the board. The ceramic capacitor is a multi-layer ceramic capacitor (MLCC), for example.

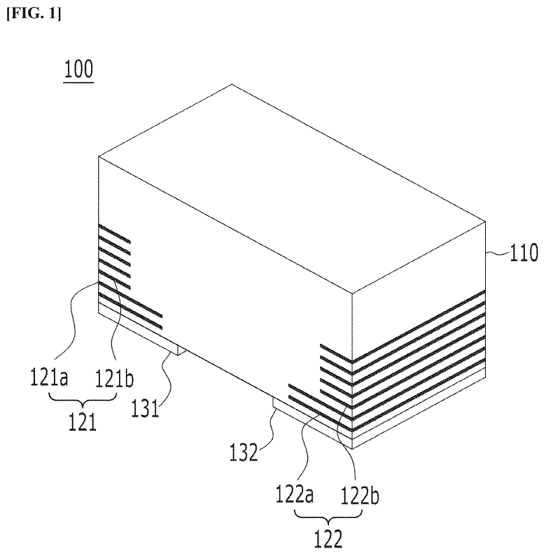

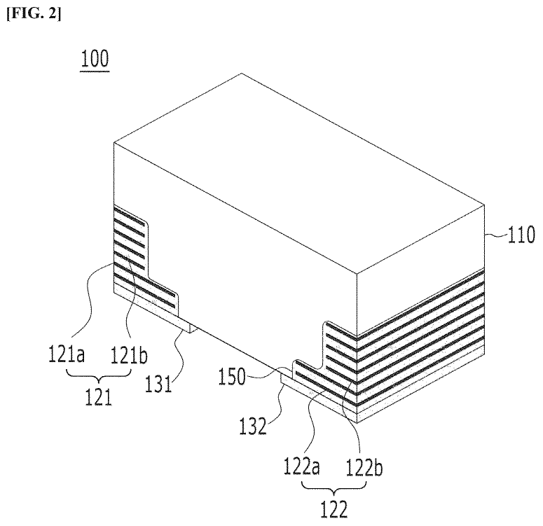

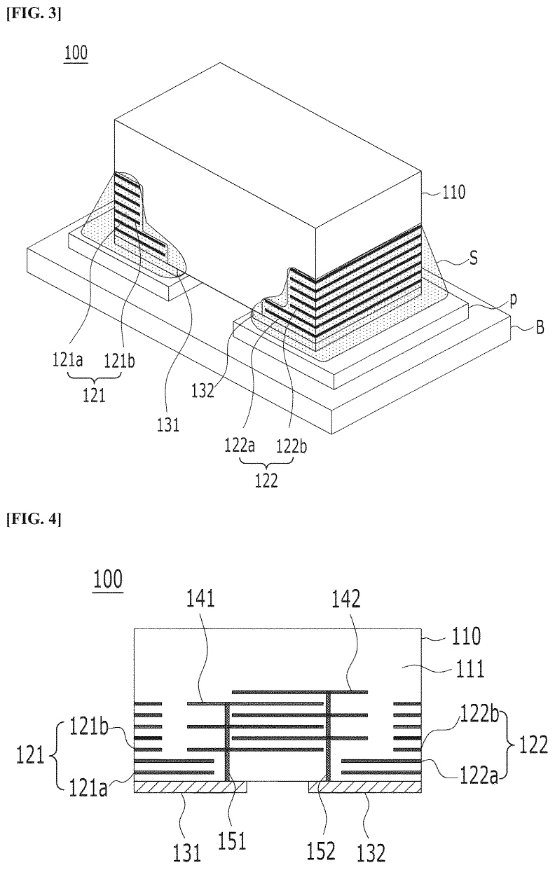

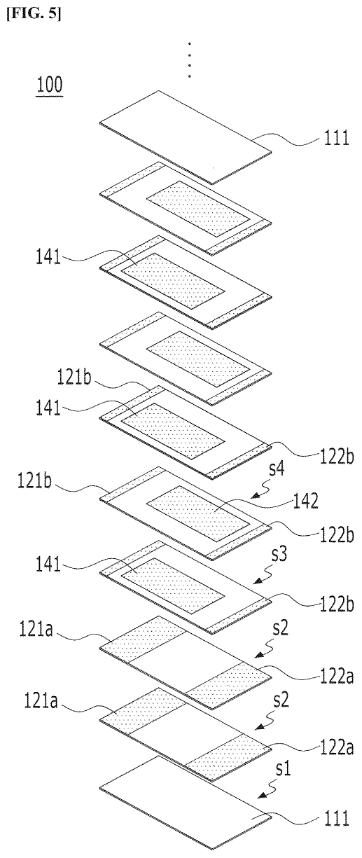

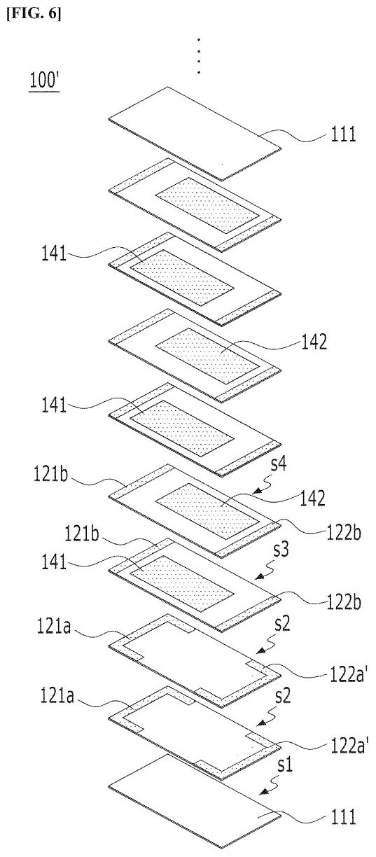

FIG. 1 is a perspective view illustrating a ceramic capacitor according to a first embodiment of the present disclosure. FIG. 2 is a perspective view illustrating a form in which a plating layer has been formed in the ceramic capacitor according to the first embodiment of the present disclosure. FIG. 3 is a perspective view illustrating a form in which the ceramic capacitor according to the first embodiment of the present disclosure has been soldered to a board. FIG. 4 is a longitudinal cross-sectional view illustrating the ceramic capacitor according to the first embodiment of the present disclosure. FIG. 5 is an exploded perspective view illustrating the ceramic capacitor according to the first embodiment of the present disclosure.

As illustrated in FIGS. 1 to 5, a ceramic capacitor 100 includes a ceramic body 110, first and second dummy electrodes 121 and 122, and first and second bottom electrodes 131 and 132.

The ceramic body 110 includes a plurality of dielectric layers. The ceramic body 110 is formed by horizontally stacking a plurality of dielectric layers 111 and then plasticizing the plurality of dielectric layers. The plurality of dielectric layers 111 is in the state in which the plurality of dielectric layers has been sintered. A boundary between adjacent dielectric layers 111 may be integrated to the extent that it is difficult to check the boundary (refer to FIG. 4).

A material of the dielectric layer 111 may be barium titanate (BaTiO₃)-based ceramics having a high dielectric constant. In addition, (Ca, Zr)(Sr, Ti)O₃-based ceramics may be used as the material that forms the dielectric layer 111, or the dielectric layer may additionally include the material. However, it is preferred that the dielectric material BaTiO₃ having a high dielectric constant is used because capacitance is proportional to the dielectric constant of dielectric.

The ceramic body 110 is formed in an approximately rectangular parallelepiped, and includes front and rear surfaces that face each other, upper and lower surfaces that face each other, and both end surfaces that face each other. The lower surface of the ceramic body 110 is a mounting surface that is mounted on a board. A surface that faces the lower surface is the upper surface. Two surfaces that are orthogonal to the upper and lower surfaces and each have a long length are the front and rear surfaces. Two surfaces that are orthogonal to the upper and lower surfaces and each have a short length are the both end surfaces.

The first and second dummy electrodes 121 and 122 are included in the ceramic body 110. The first and second dummy electrodes 121 and 122 are exposed to both end surfaces of the ceramic body 110 and the front and rear surfaces of the ceramic body 110, which neighbor the both end surfaces of the ceramic body 110. The first and second dummy electrodes 121 and 122 are for stably bonding the ceramic capacitor 100 to the board B by widening a soldered area and also increasing contact reliability by widening the area of an electrode that is connected to the board, by enabling a solder to go up the dummy electrodes when the first and second bottom electrodes 131 and 132 are soldered to the board. The first and second dummy electrodes 121 and 122 are each disposed in a plural number to a certain height over each of the first and second bottom electrodes 131 and 132, increase tensile strength of parts that are soldered and bonded to the board B, but do not contribute to the forming of capacitance. A separation distance between ends of first and second lower dummy electrodes 121a and 122a, which face each other so that the first and second dummy electrodes do not contribute to the forming of capacitance, is relatively longer than a separation distance between the first bottom electrode 131 and the second bottom electrode 132.

The first and second dummy electrodes 121 and 122 that neighbor both end surfaces of the ceramic body 110 and that are exposed to the front and rear surfaces of the ceramic body 110, respectively, each include a plurality of layers, and may each have a shape in which the length of the dummy electrode is increased from the top thereof to the bottom thereof. For example, the first and second dummy electrodes 121 and 122 that neighbor both end surfaces of the ceramic body 110 and that are exposed to the front and rear surfaces of the ceramic body 110, respectively, may each be formed in an “L” shape.

Specifically, the first and second dummy electrodes 121 and 122 include first and second lower dummy electrodes 121a and 122a and first and second upper dummy electrodes 121b and 122b, respectively. The first and second lower dummy electrodes 121a and 122a are each formed of at least one layer that is disposed over each of the first and second bottom electrodes 131 and 132. The first and second upper dummy electrodes 121b and 122b are disposed over the first and second lower dummy electrodes 121a and 122a, respectively, and are each formed of a plurality of layers in each of which the length of each dummy electrode exposed to the front and rear surfaces of the ceramic body 110 is shorter than that of each of the first and second lower dummy electrodes 121a and 122a. Specifically, the length of each of the first and second lower dummy electrodes 121a and 122a that are close to the first and second bottom electrodes 131 and 132 and that are exposed to the front and rear surfaces of the ceramic body 110 is relatively longer compared to the first and second upper dummy electrodes 121b and 122b. Accordingly, the solder can more stably go up the dummy electrode from a bottom part.

That is, the ceramic capacitor 100 includes the ceramic body 110 including the front and rear surfaces that face each other, the upper and lower surfaces that face each other, and both end surfaces that face each other and the plurality of first and second dummy electrodes 121 and 122 disposed within the ceramic body 110. The plurality of first dummy electrodes 121 are exposed to one end surface, among the both end surfaces of the ceramic body 110, and are also exposed to the front and rear surfaces of the ceramic body 110 so as to neighbor the one end surface of the ceramic body 110. The plurality of second dummy electrodes 122 is disposed within the ceramic body 110, exposed to the other end surface that is opposite to one end surface, among the both end surfaces of the ceramic body 110, and also exposed to the front and rear surfaces of the ceramic body 110 so as to neighbor the other end surface of the ceramic body 110.

The plurality of first dummy electrodes 121 includes the first lower dummy electrode 121a and the first upper dummy electrode 121b disposed over the first lower dummy electrode 121a. The length of a part of the first lower dummy electrode 121a in which the first lower dummy electrode is exposed to the front and rear surfaces of the ceramic body 110 is longer than the length in which the first upper dummy electrode 121b is exposed to the front and rear surfaces of the ceramic body 110. The plurality of second dummy electrodes 122 includes the second lower dummy electrode 122a and the second upper dummy electrode 122b disposed over the second lower dummy electrode 122a. The length of a part of the second lower dummy electrode 122a in which the second lower dummy electrode is exposed to the front and rear surfaces of the ceramic body 110 is longer than the length in which the second upper dummy electrode 122b is exposed to the front and rear surfaces of the ceramic body 110.

It is preferred that an interval between the plurality of first dummy electrodes 121 and between the plurality of second dummy electrodes 122 in a height direction thereof is 2 μm to 3 μm. When the interval between the dummy electrodes in the height direction is 2 μm to 3 μm, the solder can easily go up the dummy electrodes upon soldering. It is preferred that the first dummy electrode 121 and the second dummy electrode 122 have a symmetrical shape for stable bonding upon soldering.

One of Pd, Pt, Ag—Pd, and Ni or mixed metal thereof may be used as a material of the first and second dummy electrodes 121 and 122. One of Au, Ag, and Cu or mixed metal thereof may be additionally plated. Alternatively, one of Au, Ag, and Cu or mixed metal thereof may be used as the material of the first and second dummy electrodes 121 and 122.

The first and second bottom electrodes 131 and 132 are disposed on both sides of the bottom of the ceramic body 110. The first and second bottom electrodes 131 and 132 are external electrodes for a connection with the board. The first and second bottom electrodes 131 and 132 may be formed by plating a bottom electrode material on both sides of the bottom of the ceramic body 110.

Ag or Cu having high electrical conductivity may be used as the bottom electrode material. A plating layer may be further formed on each of the first and second bottom electrodes 131 and 132 by plating Ni and Sn. If the Ni and Sn plating layers are further formed on each of the first and second bottom electrodes 131 and 132, an adhesive force for the board can be increased and moisture resistance can be improved.

As illustrated in FIG. 2, in the ceramic capacitor 100, a plating layer 150 that covers the first and second dummy electrodes 121 and 122 may be further formed at each of parts of the first and second dummy electrodes 121 and 122, which are exposed to the front and rear surfaces of the ceramic body 110.

The plating layer 150 is formed at parts of the first and second dummy electrodes 121 and 122 that are exposed to both end surfaces of the ceramic body 110 and parts of the first and second dummy electrodes 121 and 122 that neighbor the both end surfaces of the ceramic body 110 and that are exposed to the front and rear surfaces of the ceramic body 110, respectively. Furthermore, the plating layer 150 may also be formed in the first and second bottom electrodes 131 and 132 so that the first dummy electrode 121 and the second dummy electrode 122 are connected to the first and second bottom electrodes 131 and 132. If the plating layer 150 that connects the first and second dummy electrodes 121 and 122 and the first and second bottom electrodes 131 and 132 is further formed, soldering can be performed more stably as the solder S goes up the plating layer upon soldering, and the oxidation of the dummy electrodes 121 and 122 in the air can also be prevented. The plating layer may be made of one of Au, Ag, and Cu or mixed metal thereof.

As illustrated in FIG. 3, in the ceramic capacitor 100, the first and second dummy electrodes 121 and 122 are exposed to both end surfaces of the ceramic body 110 and the front and rear surfaces of the ceramic body 110 that neighbor the both end surfaces of the ceramic body 110, respectively. Accordingly, a soldered area is widened and a circuit pattern p of the board B is stably bonded to the ceramic capacitor 100 because the solder S goes up the dummy electrodes 121 and 122 when the first and second bottom electrodes 131 and 132 are soldered to the board B. Furthermore, contact reliability is improved because the area of the solder that is connected to the board B is widened up to the front and rear surfaces of the ceramic body 110.

As illustrated in FIG. 4, the ceramic capacitor 100 includes first and second internal electrodes 141 and 142 and first and second vias 151 and 152. The first and second internal electrodes 141 and 142 may each be formed in various shapes. However, in an embodiment, the first and second internal electrodes 141 and 142 having shapes in which the first and second internal electrodes are connected to the first and second bottom electrodes 131 and 132 by using the first and second vias 151 and 152 are described as an example. A structure in which the first and second bottom electrodes 131 and 132 and the first and second internal electrodes 141 and 142 are connected by using the first and second vias 151 and 152 has a characteristic in which ESR is improved by reducing resistance by shortening a current path.

The first and second internal electrodes 141 and 142 include parts that are formed within the ceramic body 110, that are spaced apart from both end surfaces of the ceramic body 110 at a certain distance, and that overlap each other. The first and second internal electrodes 141 and 142 may be electrically connected to the first and second bottom electrodes 131 and 132 through the first and second vias 151 and 152. In the ceramic capacitor 100, when a voltage is applied to the first and second bottom electrodes 131 and 132, electric charges are accumulated on a part at which the first and second internal electrodes 141 and 142 overlap. In this case, capacitance is proportional to the area of a region in which the first internal electrode 141 and the second internal electrode 142 overlap each other. The first and second internal electrodes 141 and 142 may each be formed in a plural number.

The first via 151 is entirely connected to the first internal electrode 141 through the first internal electrode 141. The second via 152 is entirely connected to the second internal electrode 142 through the second internal electrode 142.

At least one of the first and second internal electrodes 141 and 142 may be formed on a dielectric layer in which each of the first and second dummy electrodes 121 and 122 has been formed. Furthermore, the remaining part of each of the first and second internal electrodes 141 and 142 may be formed on a dielectric layer in which each of the first and second dummy electrodes 121 and 122 has not been formed.

The first and second internal electrodes 141 and 142 may each be made of one of Cu, Ni, and Pd-Ag or an alloy of them. In order to suppress the oxidation of the internal electrode during a plasticizing process that is performed at a high temperature, Pd, that is, expensive precious metal, may be used as the internal electrode. However, for a cost reduction according to requirements for miniaturization and higher capacity of an MLCC, Pd—Ag, Ni, Cu, etc. may be used as the internal electrode.

The first and second vias 151 and 152 may each be made of one of Cu, Ni, and Pd—Ag or an alloy of them. Alternatively, the first and second vias 151 and 152 may be formed of a solder that fills a via hole in a soldering process.

As illustrated in FIG. 5, the ceramic capacitor 100 may have a form in which at least one layer of a second dielectric layer s2 in which the first and second lower dummy electrodes 121a and 122a have been disposed is stacked on a first dielectric layer s1 made of only dielectric and a third dielectric layer s3 in which the first and second upper dummy electrodes 121b and 122b and the first internal electrode 141 have been disposed and a fourth dielectric layer s4 in which the first and second upper dummy electrodes 121b and 122b and the second internal electrode 142 have been disposed on the second dielectric layer s2 are alternately stacked.

The first internal electrode 141 and the second internal electrode 142 each have a certain area so that the first internal electrode and the second internal electrode overlap each other, and are biased in opposite directions. Accordingly, the first internal electrode and the second internal electrode may be connected to the bottom electrodes 131 and 132, respectively, when they are connected to the corresponding bottom electrodes 131 and 132 through the vias 151 and 152.

The first and second lower dummy electrodes 121a and 122a and the first and second upper dummy electrodes 121b and 122b may be disposed to face both sides of upper surfaces of the dielectric layers s2, s3, and s4 and to be exposed to three surfaces of both ends and front and rear surfaces thereof. In a first embodiment, flat-head shapes of the first and second lower dummy electrodes 121a and 122a in which each of the first and second lower dummy electrodes is exposed to three surfaces on both sides of the upper surface of the second dielectric layer s2 are formed to face each other. The first and second upper dummy electrodes 121b and 122b are disposed to be spaced apart from the first internal electrode 141 or the second internal electrode 142. Flat-head shapes of the first and second upper dummy electrodes in which each of the first and second upper dummy electrodes is exposed to three surfaces at both ends and on front and rear surfaces of each of the third and fourth dielectric layers s3 and s4 are formed to face each other.

The first and second bottom electrodes 131 and 132 are disposed on both sides on a lower surface of the first dielectric layer s1 that is disposed at the lowest layer. Specifically, the first and second bottom electrodes 131 and 132 may each be formed by printing or applying the bottom electrode material to both sides of the bottom of the ceramic body 110 that is manufactured by stacking dielectric layers and compressing, cutting, and plasticizing the dielectric layers.

FIG. 6 is an exploded perspective view illustrating a modified example of the ceramic capacitor according to the first embodiment of the present disclosure.

A ceramic capacitor 100′ of the modified example of FIG. 6 is different in the shapes of first and second lower dummy electrodes 121a′ and 122a′ compared to the first embodiment.

The first and second lower dummy electrodes 121a′ and 122a′ are formed to have E shapes that face each other and that are each exposed to three surfaces on both sides of the upper surface of the second dielectric layer s2. The first and second lower dummy electrodes 121a′ and 122a′ each having the E shape can prevent parasitic capacitance attributable to the dummy electrodes 121a′ and 122a′ from occurring, by preventing the dummy electrodes 121a′ and 122a′ and the internal electrodes 141 and 142 from overlapping while securing a certain length in which each of the first and second lower dummy electrodes 121a′ and 122a′ is exposed on each of the front and rear surfaces of the ceramic body 110. This enables an accurate capacity design using the internal electrodes 141 and 142 by preventing the dummy electrodes 121a′ and 122a′ from contributing to the forming of capacitance.

In the aforementioned first embodiment, although the ceramic capacitor having the bottom electrodes is soldered to the board, a soldered area is widened by the dummy electrodes that are exposed to both ends and front and rear surfaces of the ceramic body. Accordingly, the ceramic capacitor can be stably bonded to the board due to increased bonding power of the solder. In particular, the dummy electrode that is exposed to the front and rear surfaces of the ceramic body enables more firm bonding because the solder has a shape in which the solder surrounds the front and rear surfaces of the ceramic body 110 in the L shape.

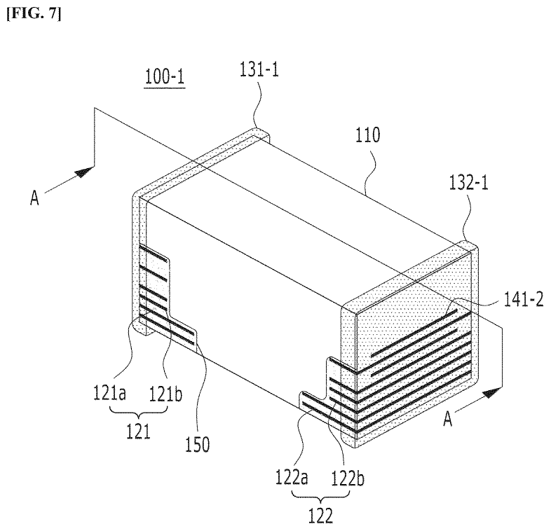

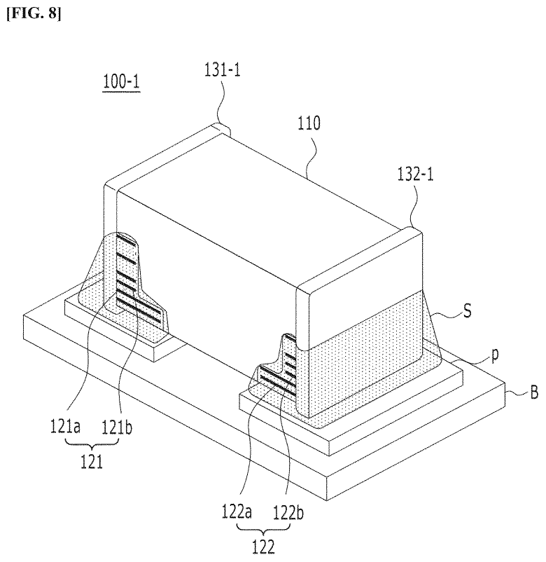

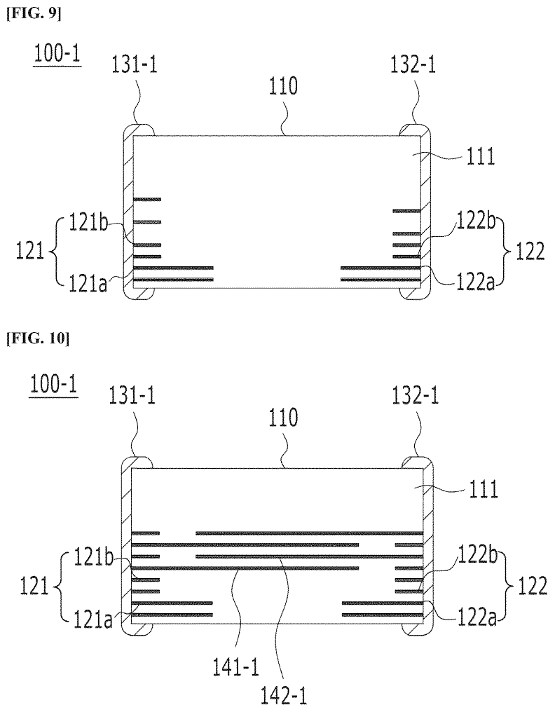

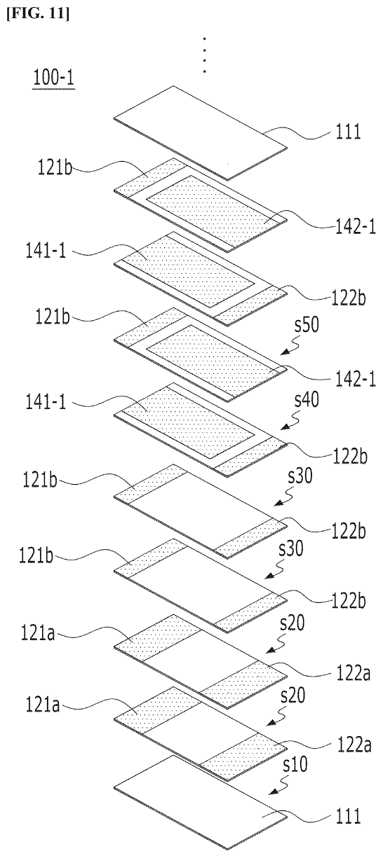

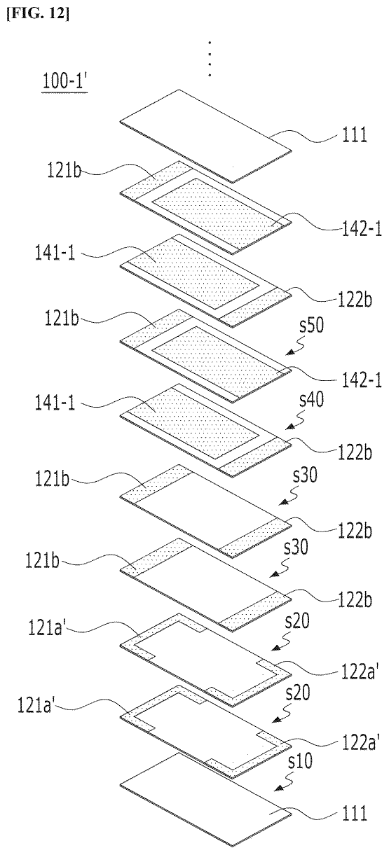

FIG. 7 is a perspective view illustrating a ceramic capacitor according to a second embodiment of the present disclosure. FIG. 8 is a perspective view illustrating a form in which the ceramic capacitor according to the second embodiment of the present disclosure has been soldered to a board. FIG. 9 is a front view illustrating the ceramic capacitor according to the second embodiment of the present disclosure. FIG. 10 is a longitudinal cross-sectional view (a cross section of A-A in FIG. 7) illustrating the ceramic capacitor according to the second embodiment of the present disclosure. FIG. 11 is an exploded perspective view illustrating the ceramic capacitor according to the second embodiment of the present disclosure.

As illustrated in FIGS. 7 to 11, a ceramic capacitor 100-1 of the second embodiment includes a ceramic body 110, first and second dummy electrodes 121 and 122, and first and second external electrodes 131-1 and 132-1.

The ceramic body 110 includes a plurality of dielectric layers. The ceramic body 110 is formed by horizontally stacking a plurality of dielectric layers 111 and then plasticizing the plurality of dielectric layers. The plurality of dielectric layers 111 is in the state in which the plurality of dielectric layers has been sintered. A boundary between adjacent dielectric layers 111 may be integrated to the extent that it is difficult to check the boundary.

A material of the dielectric layer 111 may be barium titanate (BaTiO₃)-based ceramics having a high dielectric constant. In addition, (Ca, Zr)(Sr, Ti)O₃-based ceramics may be used as the material that forms the dielectric layer 111, or the dielectric layer may additionally include the material. However, it is preferred that the dielectric material BaTiO₃ having a high dielectric constant is used because capacitance is proportional to the dielectric constant of dielectric.

The ceramic body 110 is formed in an approximately rectangular parallelepiped shape, and includes front and rear surfaces that face each other, upper and lower surfaces that face each other, and both end surfaces that face each other.

The first and second dummy electrodes 121 and 122 are included in the ceramic body 110. The first and second dummy electrodes 121 and 122 are exposed to both end surfaces of the ceramic body 110, respectively, and the front and rear surfaces of the ceramic body 110, respectively, which neighbor the both end surfaces of the ceramic body 110. The first and second dummy electrodes 121 and 122 are for stably bonding the ceramic capacitor 100 to a board B by widening a soldered area and also increasing contact reliability by widening the area of an electrode that is connected to the board, by enabling a solder to go up the dummy electrodes on the front and rear surfaces of the ceramic body 110 when the first and second external electrodes 131-1 and 132-1 are soldered to the board.

The first and second dummy electrodes 121 and 122 are each disposed to a certain height in a plural number from a lower side of the ceramic body 110 to an upper side thereof, increase tensile strength of parts that are soldered and bonded to the board B, but do not contribute to the forming of capacitance.

The first and second dummy electrodes 121 and 122 that neighbor both end surfaces of the ceramic body 110, respectively, and that are exposed to the front and rear surfaces of the ceramic body 110, respectively, are each formed of a plurality of layers, and may each have a shape in which the length of each of the first and second dummy electrodes is increased from the top thereof toward the bottom thereof. For example, the first and second dummy electrodes 121 and 122 that neighbor both end surfaces of the ceramic body 110, respectively, and that are exposed to the front and rear surfaces of the ceramic body 110, respectively, may each be formed in an “L” shape.

Specifically, the first and second dummy electrodes 121 and 122 include first and second lower dummy electrodes 121a and 122a and first and second upper dummy electrodes 121b and 122b. The first and second lower dummy electrodes 121a and 122a are each formed of at least one layer that is disposed close to the lower surface of the ceramic body 110. The first and second upper dummy electrodes 121b and 122b are disposed over the first and second lower dummy electrodes 121a and 122a, respectively, and are each formed of a plurality of layers in each of which the length of each upper dummy electrode exposed to the front and rear surfaces of the ceramic body 110 is shorter than that of each of the first and second lower dummy electrodes 121a and 122a.

Specifically, the length of each of the first and second lower dummy electrodes 121a and 122a that are adjacent to the lower surface of the ceramic body 110 and that are exposed to the front and rear surfaces of the ceramic body 110 is relatively longer than that of each of the first and second upper dummy electrodes 121b and 122b so that the solder can go up the dummy electrodes 121 and 122 on the front and rear surfaces of the ceramic body 110.

An interval between the first dummy electrodes 121 and between the second dummy electrodes 122 in a height direction thereof may be 2 μm to 3 μm. When the interval between the first dummy electrodes 121 and between the second dummy electrodes 122 in the height direction is 2 μm to 3 μm, the solder can easily go up the dummy electrodes 121 and 122 upon soldering.

One of Pd, Pt, Ag—Pd, and Ni or mixed metal thereof may be used as a material of the first and second dummy electrodes 121 and 122. One of Au, Ag, and Cu or mixed metal thereof may be additionally plated. Alternatively, one of Au, Ag, and Cu or mixed metal thereof may be used as the material of the first and second dummy electrodes 121 and 122.

In the ceramic capacitor 100-1, a plating layer 150 that covers the first and second dummy electrodes 121 and 122 may be further formed at each of parts of the first and second dummy electrodes 121 and 122, which are exposed to the front and rear surfaces of the ceramic body 110. The plating layer 150 serves to prevent the oxidation of the first and second dummy electrodes 121 and 122 that are exposed to the outside, and enables the solder to easily go up the plating layer 150 upon soldering for mounting the ceramic capacitor 100-1 on the board B.

The first and second external electrodes 131-1 and 132-1 are disposed in both end surfaces of the ceramic body 110, respectively. The first and second external electrodes 131-1 and 132-1 are connected to the board B. The first and second external electrodes 131-1 and 132-1 may be formed by plating an external electrode material on the both end surfaces of the ceramic body 110.

Ag or Cu having high electrical conductivity may be used as the external electrode material. A plating layer may be further formed on each of the first and second external electrodes 131-1 and 132-1 by plating Ni and Sn. If the Ni and Sn plating layers are further formed on the first and second bottom electrodes 131 and 132, an adhesive force for the board can be increased and moisture resistance can be improved.

As illustrated in FIG. 8, in the ceramic capacitor 100-1, the first and second dummy electrodes 121 and 122 are exposed to both end surfaces of the ceramic body 110, respectively, and the front and rear surfaces of the ceramic body 110 that neighbor the both end surfaces of the ceramic body 110, respectively. Accordingly, when the first and second external electrodes 131-1 and 132-1 are soldered to the board B, a soldered area is widened and the ceramic capacitor 100 is stably bonded to a circuit pattern p of the board B because the solder S goes up the dummy electrodes 121 and 122 that are exposed to the front and rear surfaces of the ceramic body 110. Furthermore, contact reliability can be improved because the area of the solder that is connected to the board B is widened up to the front and rear surfaces of the ceramic body 110.

As illustrated in FIGS. 9 and 10, the ceramic capacitor 100-1 includes first and second internal electrodes 141-1 and 142-1. The first and second internal electrodes 141-1 and 142-1 are formed within the ceramic body 110. The first internal electrode 141-1 is exposed to one end surface, among both end surfaces of the ceramic body 110. The second internal electrode 142-1 is exposed the other end surface, among the both end surfaces of the ceramic body 110, and includes a part that overlaps the first internal electrode 141-1.

The first and second internal electrodes 141-1 and 142-1 are electrically connected to the first and second external electrodes 131-1 and 132-1, respectively, which are disposed in both end surfaces of the ceramic body 110, respectively. In the ceramic capacitor 100-1, when a voltage is applied to the first and second external electrodes 131-1 and 132-1, electric charges are accumulated on a part at which the first and second internal electrodes 141-1 and 142-1 overlap. In this case, capacitance is proportional to the area of a region in which the first internal electrode 141-1 and the second internal electrode 142-1 overlap each other. The first and second internal electrodes 141-1 and 142-1 may each be formed in a plural number.

A part of the first and second internal electrodes 141-1 and 142-1 may be formed on a dielectric layer in which the first dummy electrode 121 or the second dummy electrode 122 has been formed. For example, the second upper dummy electrode 122b may be formed in at least one of dielectric layers in each of which the first internal electrode 141-1 has been formed. The first upper dummy electrode 121b may be formed in at least one of dielectric layers in each of which the second internal electrode 142-1 has been formed. The bending, a crack, etc. of the ceramic capacitor upon plasticizing can be prevented by making similar the density of a region in which the first internal electrode 141-1 and the second internal electrode 142-1 overlap and the density of an edge in which the first internal electrode 141-1 and the second internal electrode 142-1 do not overlap in the first upper dummy electrode 121b that is disposed between the first internal electrodes 141-1 and the second upper dummy electrode 122b that is disposed between the second internal electrodes 142-1, in a height direction thereof.

The first and second internal electrodes 141-1 and 142-1 are exposed through both end surfaces of the ceramic body 110, and are not exposed to the front and rear surfaces thereof.

The first and second internal electrodes 141-1 and 142-1 may each be made of one of Cu, Ni, and Pd—Ag or an alloy of them. In order to suppress the oxidation of the internal electrode during a plasticizing process that is performed at a high temperature, Pd, that is, expensive precious metal, may be used as the internal electrode. However, for a cost reduction according to requirements for miniaturization and higher capacity of an MLCC, Pd—Ag, Ni, Cu, etc. may be used as the internal electrode.

The first and second dummy electrodes 121 and 122 do not overlap the first and second internal electrodes 141-1 and 142-1 so that the first and second dummy electrodes do not contribute to the forming of capacitance.

As illustrated in FIG. 11, the ceramic capacitor 100-1 may have a form in which a second dielectric layer s20 of at least one layer in which the first and second lower dummy electrodes 121a and 122a have been disposed is stacked on a first dielectric layer s10 made of only dielectric, a third dielectric layer s30 of at least one layer in which the first and second upper dummy electrodes 121b and 122b have been disposed is stacked on the second dielectric layer s20, and a fourth dielectric layer s40 in which the first internal electrode 141-1 and the second upper dummy electrode 122b have been disposed and a fifth dielectric layer s50 in which the first upper dummy electrode 121b and the second internal electrode 142-1 have been disposed are alternately stacked on the third dielectric layer s30.

The first internal electrode 141-1 and the second internal electrode 142-1 each have a certain area so that the first internal electrode and the second internal electrode can overlap each other, and may be exposed through their ends and connected to the corresponding external electrodes 131-1 and 131-2.

The first and second lower dummy electrodes 121a and 122a and the first and second upper dummy electrodes 121b and 122b may be disposed to face both sides of upper surfaces of the second and third dielectric layers s20 and s30 and may each be exposed to three surfaces at the both ends and front and rear surfaces thereof. In a second embodiment, flat-head shapes of the first and second lower dummy electrodes 121a and 122a, which are exposed to three surfaces on both sides of the upper surface of the second dielectric layer s20, are formed to face each other. Flat-head shapes of the first and second upper dummy electrodes 121b and 122b disposed in the third dielectric layer s30, which are exposed to three surfaces at both ends and front and rear surfaces of the third dielectric layer s30, are formed to face each other.

The second upper dummy electrode 122b that is disposed in the fourth dielectric layer s40 is disposed to be spaced apart from the first internal electrode 141-1, and has a flat-head shape that is exposed to three surfaces at the other end and front and rear surfaces of the fourth dielectric layer s40.

The first upper dummy electrode 121b that is disposed in the fifth dielectric layer s50 is disposed to be spaced apart from the second internal electrode 142-1, and has a flat-head shape that is exposed to three surfaces at one end and front and rear surfaces of the fifth dielectric layer s50.

The first and second external electrodes 131-1 and 132-1 may each be formed by printing or applying the external electrode material to both end surfaces of the ceramic body 110 that is manufactured by stacking dielectric layers and compressing, cutting, and plasticizing the dielectric layers.

FIG. 12 is an exploded perspective view illustrating a modified example of the ceramic capacitor according to the second embodiment of the present disclosure.

A ceramic capacitor 100-1′ of the modified example of FIG. 12 is different in the shapes of first and second lower dummy electrodes 121a′ and 122a′ compared to the second embodiment.

The E shapes of the first and second lower dummy electrodes 121a′ and 122a′, which are exposed to three surfaces on both sides of the upper surface of the second dielectric layer s20 are formed to face each other. The first and second lower dummy electrodes 121a′ and 122a′ each having the E shape can prevent parasitic capacitance attributable to the dummy electrodes 121a′ and 122a′ from occurring, by preventing the dummy electrodes 121a′ and 122a′ and the internal electrode 141-1 and 142-1 from overlapping while securing a certain length in which the first and second lower dummy electrodes 121a′ and 122a′ are exposed to the front and rear surfaces of the ceramic body 110. This enables an accurate capacity design using the internal electrode 141-1 and 142-1 by preventing the dummy electrodes 121a′ and 122a′ from contributing to the forming of capacitance.

In the aforementioned second embodiment, a soldered area is widened by the dummy electrodes that are exposed to the front and rear surfaces of the ceramic body although the ceramic capacitor having the external electrodes is soldered to a board. Accordingly, the ceramic capacitor can be stably bonded to a board due to increased bonding power of a solder. Furthermore, the occurrence of a crack when the ceramic capacitor is mounted on the board can be prevented because the dummy electrodes are disposed to a part that is under a lot of stress and reinforces tensile strength of the ceramic capacitor 100-1.

The ceramic capacitor of the aforementioned embodiments may be used as an MLCC which is applied to various items, such as smartphones, PC, TV, and electric vehicles.

The above description is merely a description of the technical spirit of the present disclosure, and those skilled in the art may change and modify the present disclosure in various ways without departing from the essential characteristic of the present disclosure. Accordingly, the embodiments described in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all of technical spirits within an equivalent range of the present disclosure should be construed as being included in the scope of rights of the present disclosure.

1. A ceramic capacitor comprising:
a ceramic body comprising front and rear surfaces that face each other, upper and lower surfaces that face each other, and both end surfaces that face each other;
a plurality of first dummy electrodes disposed within the ceramic body, exposed to one end surface, among the both end surfaces of the ceramic body, and also exposed to the front and rear surfaces of the ceramic body so as to neighbor the one end surface of the ceramic body; and
a plurality of second dummy electrodes disposed within the ceramic body, exposed to the other end surface that is opposite to the one end surface, among the both end surfaces of the ceramic body, and also exposed to the front and rear surfaces of the ceramic body so as to neighbor the other end surface of the ceramic body.

2. The ceramic capacitor of claim 1, wherein:
the plurality of first dummy electrodes comprises a first lower dummy electrode and a first upper dummy electrode disposed over the first lower dummy electrode, and
a length of a part of the first lower dummy electrode, which is exposed to the front and rear surfaces of the ceramic body, is longer than a length in which the first upper dummy electrode is exposed to the front and rear surfaces of the ceramic body.

3. The ceramic capacitor of claim 1, further comprising a first bottom electrode and a second bottom electrode disposed on both sides of the lower surface of the ceramic body,
wherein a separation distance between ends of the first dummy electrode and the second dummy electrode at which the first dummy electrode and the second dummy electrode face each other is relatively longer than a separation distance between the first bottom electrode and the second bottom electrode.

4. The ceramic capacitor of claim 1, wherein an interval between the first dummy electrodes and between the second dummy electrodes in a height direction thereof is 2 μm to 3 μm.

5. The ceramic capacitor of claim 1, wherein the first dummy electrode and the second dummy electrode have a symmetrical shape.

6. The ceramic capacitor of claim 1, wherein in the plurality of first dummy electrodes, a part that is exposed to the front surface of the ceramic body forms an “L” shape.

7. The ceramic capacitor of claim 1, wherein in the plurality of first dummy electrodes, a part that is exposed to the front surface of the ceramic body has a shape in which the length of the part is increased from a top thereof toward a bottom thereof.

8. The ceramic capacitor of claim 3, further comprising:
one or more first and second internal electrodes formed within the ceramic body and comprising parts that are spaced apart from the both end surfaces of the ceramic body at a certain distance and that overlap each other; and
first and second vias configured to connect the first and second internal electrodes to the first and second bottom electrodes.

9. The ceramic capacitor of claim 8, wherein:
the first via is entirely connected to the first internal electrode through the first internal electrode, and
the second via is entirely connected to the second internal electrode through the second internal electrode.

10. The ceramic capacitor of claim 8, wherein at least one of the first and second internal electrodes is formed on a dielectric layer in which the first and second dummy electrodes have been formed.

11. The ceramic capacitor of claim 1, wherein a plating layer that covers each of the first and second dummy electrodes is further formed at each of parts of the first and second dummy electrodes, which are exposed to the front and rear surfaces of the ceramic body.

12. The ceramic capacitor of claim 1, wherein:
the plurality of second dummy electrodes comprises a second lower dummy electrode and a second upper dummy electrode disposed over the second lower dummy electrode, and
a length of a part of the second lower dummy electrode, which is exposed to the front and rear surfaces of the ceramic body, is longer than a length in which the second upper dummy electrode is exposed to the front and rear surfaces of the ceramic body.

13. The ceramic capacitor of claim 2, further comprising:
a first internal electrode disposed within the ceramic body and exposed to one end surface, among the both end surfaces of the ceramic body,
a second internal electrode disposed within the ceramic body, exposed to the other end surface that is opposite to the one end surface, among the both end surfaces of the ceramic body, and comprising a part that overlaps the first internal electrode;
a first external electrode disposed in the one end surface of the ceramic body and connected to the first internal electrode; and
a second external electrode disposed in the other end surface of the ceramic body and connected to the second internal electrode.

14. The method of claim 13, wherein:
the second dummy electrode is formed in at least one of dielectric layers in each of which the first internal electrode has been formed, and
the first dummy electrode is formed in at least one of dielectric layers in each of which the second internal electrode has been formed.

15. The ceramic capacitor of claim 1, wherein when the ceramic capacitor is mounted on a board, a solder part in which a solder goes up the first and second dummy electrodes and further surrounds a part of the front and rear surfaces of the ceramic body is formed at each of a part of the first dummy electrode, which is exposed to the front and rear surfaces of the ceramic body, and a part of the second dummy electrode, which is exposed to the front and rear surfaces of the ceramic body.

16. The ceramic capacitor of claim 1, wherein the first dummy electrode and the second dummy electrode do not overlap the first and second internal electrodes.
